(19) United States
(12) Patent Application Publication
(10) Pub. No.: US 2003/0123745 A1
(43) Pub. Date: Jul. 3, 2003

(54) Method and apparatus for compression and reconstruction of electronic handwriting

(76) Inventor: Mattias Bryborn, Lund (SE)

Correspondence Address: BIRCH STEWART KOLASCH & BIRCH, PO BOX 747, FALLS CHURCH, VA, 22040-0747, US

(21) Appl. No.: 10/329,812

(22) Filed: Dec. 27, 2002

Related U.S. Application Data
(60) Provisional application No. 60/346,996, filed on Jan. 11, 2002.

(30) Foreign Application Priority Data
Dec. 28, 2001 (SE) 0104468-4

(51) Int. Cl. G06K 9/36

(52) U.S. Cl. 382/242

(57) ABSTRACT

According to a method for compressing electronic handwriting, the handwriting is converted into digital data representing a sequence of points along a writing movement carried out by a writing tool. A given point is defined, for storage, relative to at least one previous point in the sequence. The given point is defined in a coordinate system, the orientation of which is dependent upon at least one previous point in the sequence.

### FIELD OF THE INVENTION

The present invention relates to electronic recording of handwritten information. More specifically, the invention relates to compression of electronic handwriting, the handwriting being converted into digital data representing a sequence of points along a writing movement carried out by a writing tool and a given point being defined, for storage, relative to at least one previous point in the sequence.

### BACKGROUND ART

Today electronic recording of handwritten information has many applications. An example of a writing tool suitable for this purpose is described in WO 01/71473 in the form of an electronic pen. An electronic pen will be used throughout this document to represent a writing tool suitable for recording handwritten information, without the invention in any way being restricted to such a pen.

Electronic pens are intended to be used in hand-held and portable applications, and for this reason, because of consequent restrictions on power consumption, space and cost, it is necessary to store the recorded electronic handwriting as efficiently as possible and in a way that uses as little memory as possible.

U.S. Pat. No. 6,101,280 describes a method and a device for compressing electronic handwriting, consisting of a sequence of pen strokes, each of which constitutes a sequence of pairs of (x,y)-coordinates for points arranged (sampled) in time order along the pen stroke. In order to specify each pair of coordinates with adequate resolution, nominally one 16-bit integer is required for the x-coordinate and the y-coordinate, respectively. Prior-art technique, including that from U.S. Pat. No. 6,101,280, shows, however, a series of measures that can be taken in order to reduce the storage space required for the pen strokes.

In the first place, many of the recorded points can be eliminated without significantly deteriorating the visual quality when the electronic handwriting is later to be recreated, for example displayed on a screen or printed. For this purpose, so-called resampling of the sequence of recorded points is carried out before storage. The Douglas-Peucker's algorithm is often used for resampling a discrete curve, for example consisting of a sequence of points along a recorded pen stroke, and this is carried out in the following way. A curve segment between a first point and a second point, which is located at a distance from the first point, has a straight line drawn experimentally between the first and the second point. If the maximal distance between this line and any point on the curve segment is less than a limit value, the curve segment is replaced by the straight line. A straight line can be represented by considerably less data than a curve segment, whereby the saving in storage space is evident. On the other hand, if the maximal distance exceeds the limit value, a first shorter line is created between the first point and a midpoint on the curve segment and a second shorter line is created between this midpoint and the second point, the above procedure being repeated recursively on these shorter lines.

Once the pen stroke has been sampled, further data reduction can be achieved by not storing the points' coordinates as absolute values but instead as difference or delta values relative to the immediately preceding point. It is normally sufficient to have 8 bits per relative coordinate, compared to twice that for absolute coordinates. Even better data reduction is achieved by making use of some form of prediction or extrapolation, for example polynomial approximation, of the expected position of a given point based on a number of preceding points in the sequence. Each point will thus be represented by the error or deviation between its expected position and its actual position.

Finally, data-compressing source coding is used—often statistical coding such as Huffman coding or arithmetic coding—on the coordinates that have been relative coded in accordance with the above.

By means of the measures above, a considerable reduction in data can be achieved compared to if all the coordinates are stored as absolute values. Analysis shows, however, that the degree of compression attained is not always what is theoretically possible.

U.S. Pat. No. 6,295,378 discloses a handwriting stroke information encoder with a processor for predicting the position of a point to be encoded based on previously encoded points and vectors which connect previously encoded points together. The actual position of a point is defined by the horizontal and vertical deviations, expressed in a fixed coordinate system, from the predicted position.

### SUMMARY OF THE INVENTION

The invention has therefore as its object to make possible an even higher degree of compression when using coding principles based on statistical source-coding algorithms of the type Huffman coding or arithmetic coding.

This object has been achieved by the realization that better data compression can be achieved by letting the recorded points along a curve of a writing movement (for example a pen stroke) be represented by relative coordinates, which are not expressed in a fixed coordinate system, but instead in a dynamic coordinate system, the orientation of which follows the curve movement and thus depends on preceding point(s) along the curve. As a result, advantage is taken of the characteristics of inter alia Western handwriting and the pattern of movement of a human hand, for example the fact that the handwriting movements usually swing slightly more to the left than to the right.

More specifically, the object is achieved by means of a method, an apparatus and a computer program product for compressing electronic handwriting and a method for reconstruction of electronic handwriting according to the independent claims.

A first aspect of the invention is thus a method for compressing electronic handwriting, where the handwriting is converted into digital data representing a sequence of points along a writing movement carried out by a writing tool and where a given point is defined, for storage, relative to at least one previous point in the sequence. The given point is defined in a coordinate system, the orientation of which is dependent upon previous point(s) in the sequence.

Here, “storage” includes storing the digital data in any storage means, including but not limited to a register in a processor (CPU), a cache memory, a random access memory or a persistent memory, either in the writing tool or in another device, permanently or temporarily (the latter case including streaming of digital data from one device to another).

The coordinate system is dynamic such that the orientation of its coordinate axes may be different for a first given point than for a second given point and depends on point(s) that precede(s) said first given point and second given point, respectively, in the sequence.

The method may in addition comprise the steps of determining a prediction of the position of the given point from N+1 preceding points in the sequence; conceptually placing the coordinate system with its origin positioned relative to the prediction in a predetermined manner and with an orientation that is dependent upon the N+1 preceding points; and determining a deviation between the given point and the prediction, expressed in the coordinate system. It should be emphasized that also in this case the given point is defined relative to at least one previous point in the sequence, as the prediction is based on the N+1 preceding points and the given point is in turn defined as a deviation between its predicted and its actual position.

The expression “placing the coordinate system with its origin positioned relative to the prediction in a predetermined manner” may include a case where the position of the prediction constitutes the origin of the coordinate system, but also an alternative case where the origin of the coordinate system is placed with a predetermined offset from the position of the prediction.

Aforesaid N+1 preceding points may be the ones that immediately precede the given point in the sequence. The prediction can be determined by approximating a polynomial of order N to the N+1 preceding points in the sequence. N may be set to 1, whereupon the polynomial will consist of a straight line and the orientation of the coordinate system will be dependent on the two immediately preceding points in the sequence. Alternatively, N can be set to 2 or to a higher number.

A polynomial prediction according to the above has the advantage that the orientation of the coordinate system, for a given point, can be determined simply by letting one of the axes of the coordinate system coincide with the tangent to the polynomial taken at a position relative to the predicted point, i.e. taken either actually at the predicted point or at a certain predetermined offset from the predicted point.

Alternatively, one of the axes of the coordinate system can instead be oriented at a predetermined angle to the tangent to the polynomial taken at a position relative to the predicted point.

The method may include compressing the deviation, and storing the compressed deviation. The compression of the deviation between the given point and the prediction may be carried out according to a predetermined coding algorithm for statistical coding. The calculations relating to the deviation that is to be compressed may be carried out by conversion to integers according to a predetermined conversion rule such as rounding off or truncating. Thus, an advantage is obtained in that the statistical coding algorithm can work on a discrete and finite number of symbols and is thereby optimized, and also—due to the conversion rule being predetermined—the introduction and accumulation of errors are avoided in the subsequent decoding and reproduction of the recorded handwriting.

A second aspect of the invention is an apparatus for recording of electronic handwriting, comprising a control unit and a storage means, the control unit being arranged to record a writing movement across a base, to determine a sequence of points along the writing movement and to store a digital representation of the points in said storage means. The control unit is arranged to determine a coordinate system for the digital representation of a given point in said sequence of points, the orientation of the coordinate system being dependent upon at least one previous point in the sequence.

The device's control unit can advantageously be arranged to carry out the method according to the first aspect of the invention. It can also advantageously be designed as an electronic pen.

A third aspect of the invention is a computer program product that can be directly read into a memory associated with a processor, comprising program code for carrying out steps according to the first aspect of the invention.

A fourth aspect of the invention is a method for reconstruction of electronic handwriting, represented by digital data that defines a sequence of points along a writing movement carried out by a writing tool. The method comprises the steps of deriving from said digital data a measure of a deviation for a given point relative to a prediction of the position of the same; determining said prediction of the position of said given point based on N+1 preceding and already reconstructed points in the sequence; conceptually placing a coordinate system with its origin positioned relative to the prediction in a predetermined manner and with an orientation that is dependent upon the N+1 preceding points; and calculating said given point using said prediction and said deviation, expressed in said coordinate system.

The method is advantageously suited for reconstruction of digital data that was compressed by the method according to the first aspect.

The second to fourth aspects of the invention have essentially the same advantages and features as the first aspect.

Other objects, advantages and characteristics of the invention are apparent from the following detailed description of the invention, from the appended claims and from the drawings.

### BRIEF DESCRIPTION OF THE DRAWINGS

The invention will now be described in more detail with reference to the accompanying drawings.

FIG. 1 is a schematic overview of a system for electronic recording of handwriting according to an embodiment, comprising among other things an electronic pen and a server for receiving entered information from the pen.

FIG. 1a illustrates an example of information—in the form of a handwritten piece of text in the Swedish language—that can be recorded electronically using an electronic pen according to FIG. 1.

FIG. 2 is a schematic drawing of the electronic pen in FIG. 1.

FIG. 3 is a schematic drawing of a position-coding pattern, which is applied to a writing base for the electronic pen in FIG. 1.

FIG. 4 shows a general block diagram for processing electronic handwriting according to the invention.

FIG. 5 is a detailed diagram of a method for compressing electronic handwriting according to a preferred embodiment of the invention.

FIGS. 6a-6e show, successively for an exemplary small number of recorded points along the curve of a writing movement, the way of working for determining the relative coordinates of the points in a dynamic coordinate system with varying orientation which follows the curve movement and is dependent upon preceding points along the curve.

FIG. 7a shows a histogram of the distribution of relative-coded x-coordinates for the text in FIG. 1a, in the case where this text is processed according to the method reproduced in FIG. 5; with the exception that all the points are given in one and the same coordinate system with fixed orientation.

FIG. 7b serves as a comparison with FIG. 7a and shows a histogram of the distribution of relative-coded x-coordinates for the text in FIG. 1a, in the case where this text is processed in complete accordance with the method reproduced in FIG. 5, that is the coordinate system is given varying orientation for the respective points according to the way of working illustrated in FIGS. 6a-6e.

FIGS. 8a and 8b correspond to FIGS. 7a and 7b respectively, but relate to y-coordinates instead.

FIG. 9 illustrates a method for reconstruction of electronic handwriting that was compressed according to the invention.

### DETAILED DESCRIPTION OF THE INVENTION

By way of introduction, general information is given about the different components of the invention. Later follows a more detailed description of the aspects that may be central to the invention.

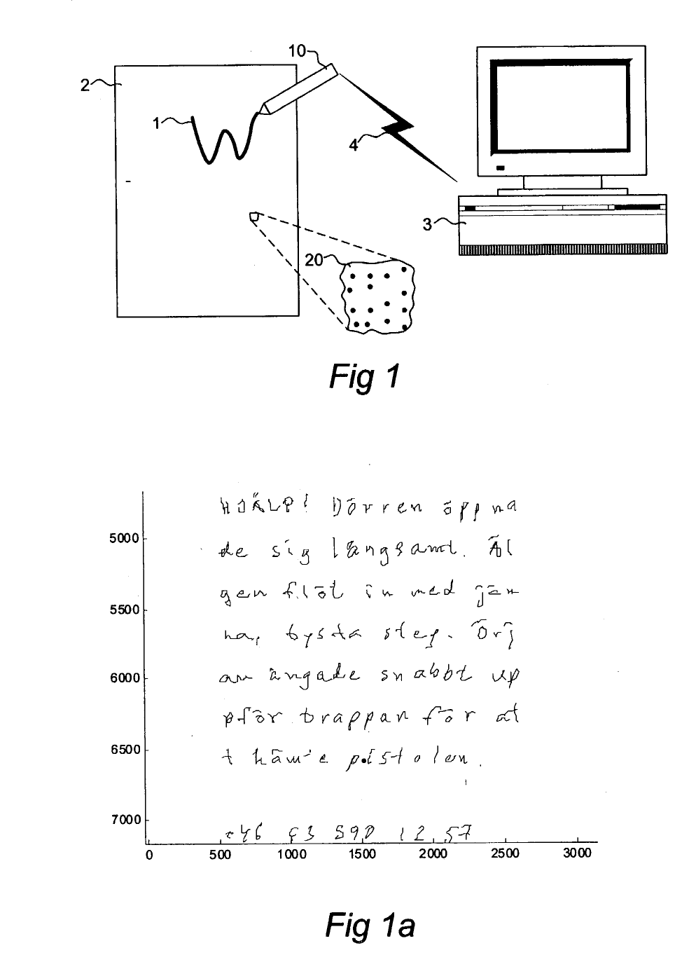

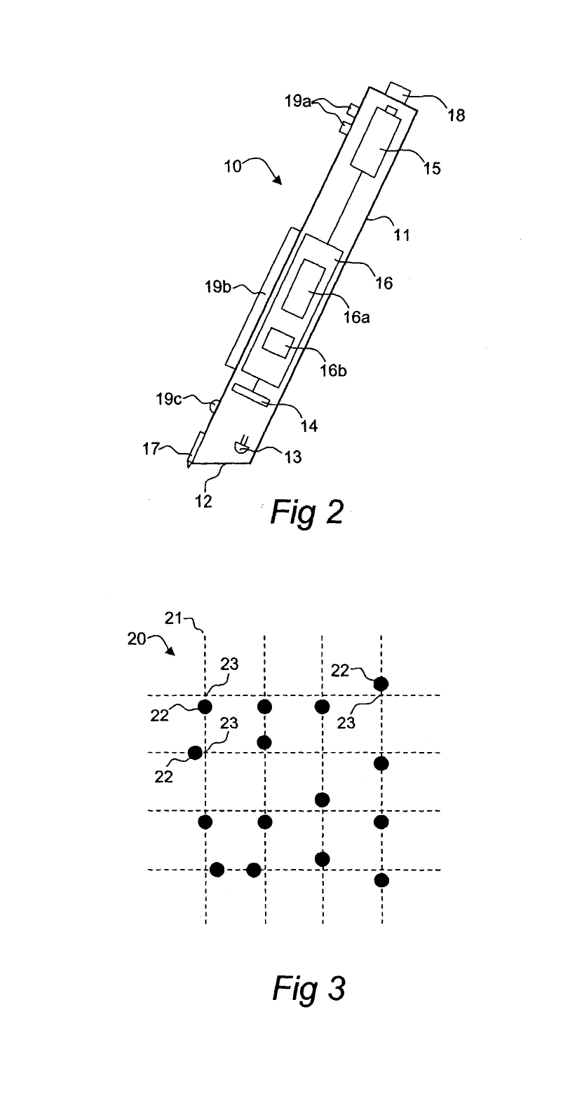

A system for electronic recording of handwriting is shown in FIG. 1. An electronic pen 10 is utilized in the system and will be described in more detail with reference to FIG. 2. When the user moves the pen 10 in the required pen movements 1 across a writing base 2, the pen movements are recorded as a plurality of digital pen strokes, which can be stored locally in the pen awaiting later transmission to a server 3 via a wireless communication link 4. In order to make this recording possible, the writing base 2 is provided with a position-coding pattern 20, which will be described in greater detail with reference to FIG. 3. A possible application, among many others, is that the handwriting entered by means of the pen movements 1 is incorporated in or attached to an e-mail message in the form of an image object of any common type (for example JPEG, GIF, SVG, PNG or TIFF), which is transmitted via a global network (WAN—“Wide Area Network”, for example the Internet) to a recipient specified by the user of the pen. Another application can be that the entered handwriting undergoes computerized text interpretation (ICR—“Intelligent Character Recognition”) in the server 3 or in some other local or remote device, including but not limited to a personal computer, a mobile telephone or a portable digital assistant, with or without the use of a network for transmitting the entered handwriting. Another application may be that the handwriting is simply displayed on a screen of the server 3, or of said local or remote device.

Irrespective of the application, the handwriting recorded by the pen 10 is generally stored temporarily in the pen, before it is transferred to the server 3, etc., at a given time.

In the following, a short description is given of the general components in the electronic pen 10 with reference to FIG. 2. A more complete description of the pen 10 is given in WO 01/16691, WO 01/26032 and WO 01/26033, which are herewith incorporated in their entirety by reference.

The electronic pen 10 has a casing or a pen body 11 which is approximately the same shape as the casing of a conventional marker pen. One end of the casing has a window 12, through which images are recorded. The casing 11 contains essentially an optics part, an electronics part and a power supply.

The optics part comprises at least one illuminating light source 13, a lens system (not shown in the Figure) and an optical image reader 14. The light source 13, suitably a light-emitting diode, illuminates a part of the base 2 which can be viewed through the window 12, preferably by means of infrared light or alternatively light of some other wavelength. The base 2 is provided with the position-coding pattern 20. An image of the base 2 is projected on the image reader 14 by means of the lens system.

The power supply for the sensor device 10 is advantageously a battery 15, which alternatively can be replaced by or supplemented by mains power (not shown).

The electronics part 16 comprises a control unit 16a to which is connected a storage means 16b. The control unit 16a is responsible for the different functions in the electronic pen 10 and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above.

The storage means 16b comprises preferably different types of memory, such as a working memory (e.g. a RAM) and a program code and persistent storage memory (e.g. a flash memory). Associated programs are stored in the storage means 16b and are executed by the control unit 16a in order to carry out the functions of the electronic pen 10.

A conventional pen point 17 is arranged on the casing 11. By means of the pen point 17, the user can write or draw physically on the base 2 by an ordinary pigment-based marking ink being deposited on the surface. The marking ink in the pen point 17 is suitably transparent to infrared light in order to avoid interference with the opto-electronic detection in the electronic pen 10.

The electronics part comprises in addition a combined transmitter and receiver (transceiver) 18 for sending information to and from a remote apparatus, such as a computer or mobile telephone, or for the transmission of information to the server 3. The combined transmitter and receiver 18 is advantageously arranged for short-range radio communication in accordance with the Bluetooth standard at 2.4 GHz in the ISM frequency band (“Industrial, Scientific and Medical”). The combined transmitter and receiver can, however, alternatively be arranged for infrared communication, such as IrDA (“Infrared Data Association”), or for cable-based communication (such as USB or RS232), or essentially for any other available standard for short-range communication between a hand-held device and a remote device.

Even though the transmission of information in the preferred embodiment takes place directly between the pen 10 and the server 3, it is to be noted that this can just as well take place via an intermediate device, for example a mobile telephone, a hand-held computer or a portable personal computer. In such a case, the intermediate device is provided with a combined transmitter/receiver corresponding to the transmitter/receiver 18 in the pen 10, by means of which information can be transmitted from the pen to the intermediate device. The latter is also provided with a suitable interface for communication with the server 3—for example a network card (for communication via a local or global network), or alternatively an analog or digital modem (for communication via a cable-based fixed telephone network, a mobile telephone network or a satellite telephone network). In this way, the information from the pen can be forwarded to the server 3 by this intermediate device. Information can also be transmitted only to a mobile telephone, a hand-held computer, a portable personal computer, etc., without any forwarding of information to a server.

In addition, the electronics part can comprise buttons 19a, by means of which the user can control the functions in the electronic pen 10. The electronic pen 10 can also comprise a display 19b, such as a liquid crystal display, and a lamp 19c for indicating status.

With reference to FIG. 3, the position-coding pattern comprises a virtual raster pattern 21, around which a plurality of marks 22 are placed. Each mark represents one of four possible values from 1 to 4. The value of each mark is represented by its actual position 22 in relation to its nominal position 23, the latter being at the intersection between a horizontal and a vertical line in the raster pattern 21. Thus, each mark 22 can be located in one of four different positions which are separated from each other in orthogonal directions from the nominal position 23. The distance is suitably not less that about ⅛ and not more than about ¼, preferably about ⅙, of the distance between two opposite raster lines.

The distance between the raster lines can, for example, be about 300 micrometers or about 254 micrometers. The latter distance is particularly suitable for printers and scanners, which often have a resolution that is a multiple of 100 dpi (dots per inch).

Each mark 22 consists of an essentially circular dot with a radius that is preferably between about 25% and about 120% of the distance between the dots and the nominal position 23. Alternatively, the marks 22 can be other geometric shapes than circular, such as rectangular, triangular, elliptical and in addition can be filled in or not filled in.

The position-coding pattern 20 can be constructed so that it codes a very large number of absolute positions. For example, 6×6 adjacent marks can in combination code a position with x- and y-coordinates. By providing the surface on the base 2 with the position-coding pattern 20, an electronic representation can be obtained of the information that is written or drawn on the base using the electronic pen 10 by repeatedly producing images of the surface when the pen 10 is moved across the surface. In these images, the marks 22 will appear as foreground objects, while the rasters 21 are only virtual and will not appear in the images.

Position-coding patterns of the type outlined above are described in greater detail in WO 01/16691, WO 01/26032 and WO 01/26033. An alternative position-coding pattern is shown in WO 00/73983. All these documents are herewith incorporated in their entirety by reference.

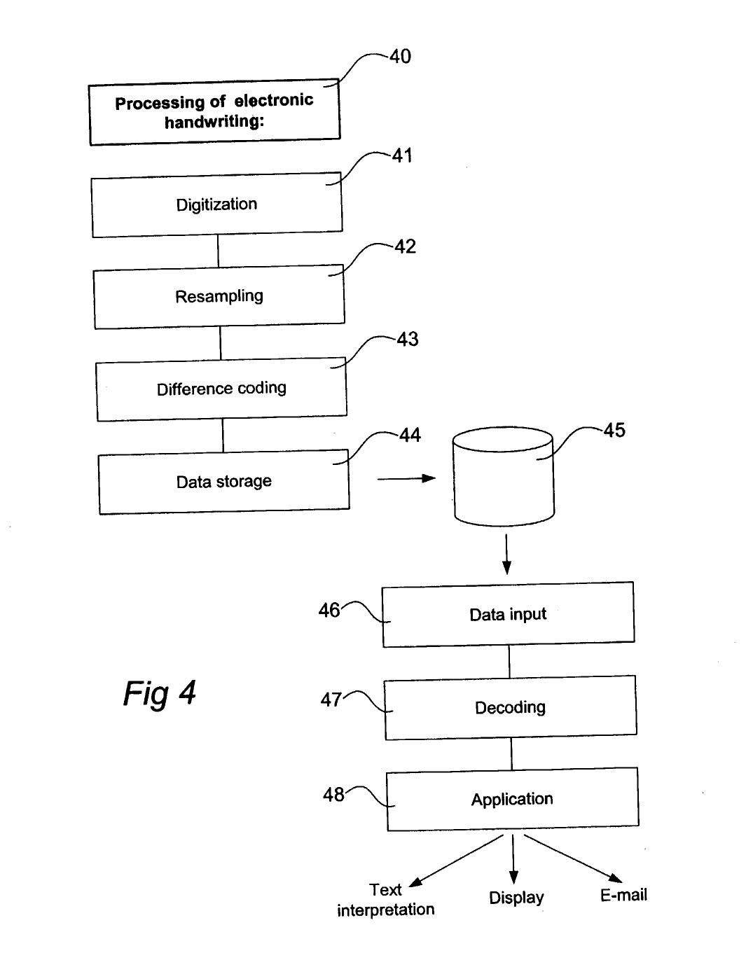

A way of working 40 for processing electronic handwriting using the electronic pen 10 and the server 3 according to a preferred embodiment of the invention will now be described with reference to FIG. 4. The steps 41-44 are carried out in the pen 10—more specifically by its control unit 16a reading program instructions from the storage means 16b and executing these, whereupon the steps 41-44 are implemented. Steps 46-48 are carried out, on the other hand, in the server 3.

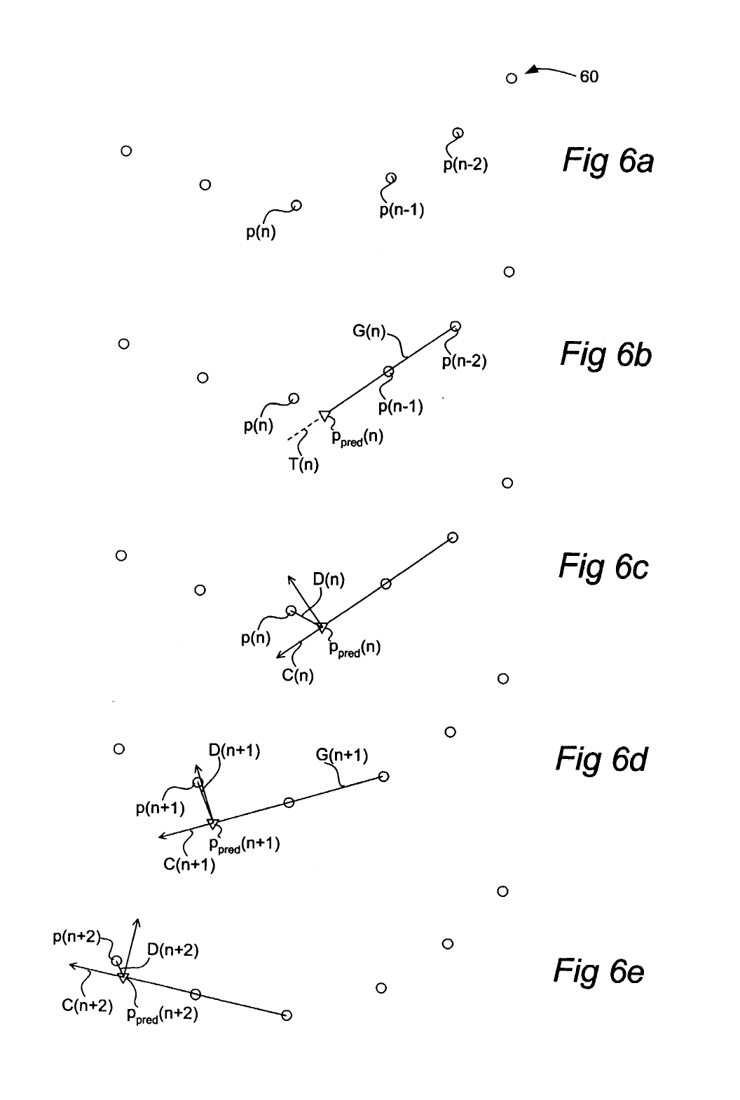

In a first step 41, the pen 10 continuously records images of the base 2 (see FIG. 1), when the user moves the pen in at least one writing movement 1. In practice, the user will carry out a large number of writing movements, each representing wholly or partially for example a letter, a number or a symbol comprised in a piece of text, for example according to FIG. 1a. In order to make this easier to understand, the remainder of the way of working 40 is, however, described with the simplified assumption that only one writing movement 1 is carried out by the user. Using the position-coding pattern 20, the pen's electronics part 16 determines a sequence of digital points 60 (see FIG. 6a) along the writing movement 1. In other words, the physical writing movement 1 is represented electronically by the sequence of digital points 60, which can be said to create a writing curve corresponding to the writing movement 1.

In a second step 42, a resampling is carried out for the sequence of digital points 60 by eliminating certain individual points, these points not being necessary for providing sufficiently good quality in later reconstruction of the writing curve. In the preferred embodiment, the resampling is carried out according to the previously described Douglas-Peucker's algorithm. This algorithm is, as has already been mentioned, well-known—an application is described, for example, in U.S. Pat. No. 6,101,280—for which reason a detailed description is omitted here but can be obtained in “Algorithms for the reduction of the number of points required to represent a digitized line or its caricature”, D. Douglas and T. K. Peucker, 1973, The Canadian Cartographer, Vol. 10, No. 2, pages 112-122. The actual resampling does not, however, constitute a central part of the invention.

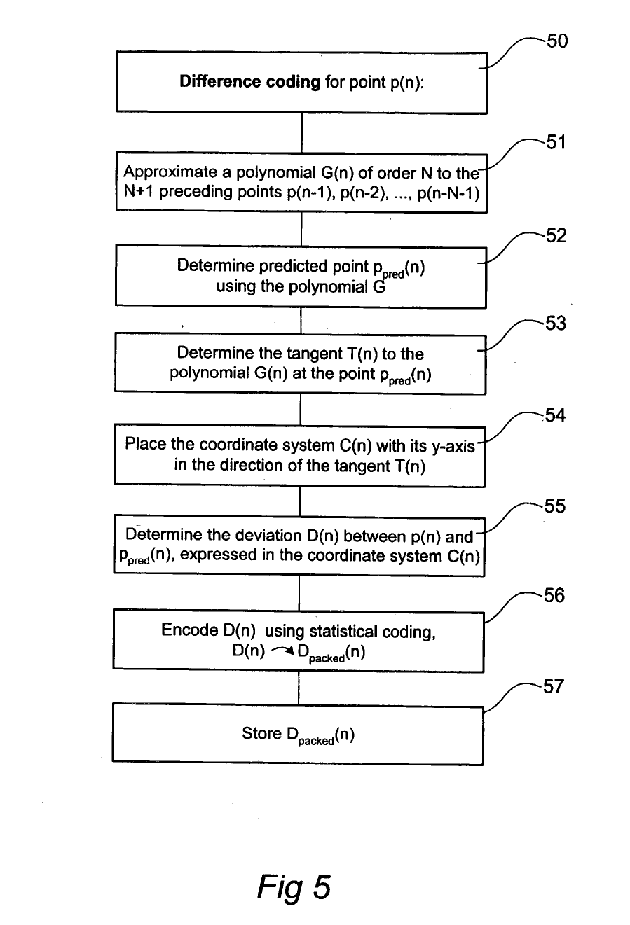

Thereafter difference coding is carried out in a step 43, which constitutes the actual data compression according to the invention and will be described in greater detail with reference to FIGS. 5 and 6a-e. The result from step 43, that is compressed relative-coded data for the electronic handwriting, is stored in a step 44 in the pen's storage means 16b for subsequent transmission, at a given time, via the wireless communication link 4 (FIG. 1) to a secondary memory in the server 3—in FIG. 4 represented symbolically by 45.

When the electronic handwriting thus recorded and transmitted to the server 3 is later to be reproduced, the stored, compressed, difference-coded data is first read in a step 46. Thereafter, a decoding of this data is carried out in a step 47, which essentially consists of the counterpart of operations in the difference coding step 43. Once the electronic handwriting has been decoded, the current application of the handwriting follows in a step 48, for example in the form of text interpretation of the handwriting, visual presentation of the same on a display screen or transmission of the handwriting as an image object in an e-mail message.

The difference coding according to step 43 in FIG. 4 is now described in detail with reference to FIGS. 5 and 6a-e. In an introductory step 50, the x- and y-coordinates are obtained, expressed in absolute 16-bit values, for a relevant point p(n) that is to be difference coded.

In a step 51, a polynomial G(n) of order N is approximated to the N+1 preceding points p(n−1), p(n−2), . . . p(n−N−1) in the sequence of points 60. The polynomial approximation is a thoroughly well-known concept within mathematics and is described, for example, in section 7.2 in “Scientific Computing—An Introductory Survey”, Michael T. Heath, McGraw-Hill, ISBN 0-07-115336-5. Tests have shown that polynomials of order 1 or 2 are optimal for the relevant digitizing speeds (which are often in the range 70-100 Hz). In addition, it has been found that polynomials of order 1 are preferable when the sequence of points has undergone resampling. As this is the case in the preferred embodiment, this is based on polynomial approximation with first order polynomials; in other words N=1 and a straight line is approximated to the N+1=1+1=2 immediately preceding points p(n−1) and p(n−2) in the sequence of points 60.

As the points in the sequence of points 60 have known time-related distances which are determined by the sampling frequency and which, in addition, are indicated in association with the resampling, in a step 52 a predicted point p_{pred}(n) can be determined by extrapolating the graph (in this case the straight line) for the polynomial G(n), see FIG. 6b.

In addition, in a step 53, the tangent T(n) to the polynomial G(n) is taken at the predicted point p_{pred}(n) In the case with N=1 according to the preferred embodiment, the determination of the tangent T(n) is particularly neat; as is shown by FIG. 6b, it is quite simply a matter of extrapolating the straight line graph for the polynomial G(n). For polynomials G(n) with higher orders than 1, the tangent T(n) is obtained by derivating the polynomial at the predicted point.

A coordinate system C(n), see FIG. 6c, is then arranged in a step 54 so that one of its axes—here the y-axis—coincides with the tangent T(n). The position of the predicted point p_{pred}(n) defines the origin of the coordinate system in the preferred embodiment.

In a step 55, a deviation D(n) is then determined between the actual point p(n) and the predicted point p_{pred}(n). This deviation is expressed in the coordinate system C(n) which was given the orientation just described.

In a step 56, the determined deviation D(n) is to be coded using a data-compression method for statistical source coding such as Huffman coding or arithmetic coding, both of which are well-known principles within the field of information theory. Statistical source-coding methods work on discrete symbol quantities and are poorly suited to continuous symbol quantities such as floating-point numbers. As the present invention works in a dynamic coordinate system with an orientation that is rotated for each point, the calculation of the coordinates for the deviation D(n) is carried out for practical reasons in decimal number representation with either fixed or floating decimal point. In order to ensure that the resulting symbol quantity is discrete rather than continuous—and thus suitable for statistical source coding—conversions are carried out from decimal numbers to integer numbers during the calculation of the coordinates for the deviation according to a predetermined conversion rule, which in the preferred embodiment consists of either rounding off to the nearest integer number or truncating to the nearest lower integer number.

In step 56, as stated, the determined deviation D(n) is coded by a data-compression method for statistical source coding. More specifically, the deviation's x- and y-coordinates, Dₓ(n) and D_{y}(n) respectively, are coded individually using statistical source coding. In the preferred embodiment, Huffman coding is used, but other statistical source coding, such as arithmetic coding, can alternatively be used. Huffman coding is described in detail in, for example, “Introduction to Data Compression”, second edition, Chapter 3, Khalid Sayood, Morgan Kaufmann Publishers, 2000. Arithmetic coding is described in Chapter 4 of the same book.

In a final step 57, the compressed deviation D_{packed}(n) is stored in the storage means 16b, for later transmission to the server 3.

The method according to steps 50-57 in FIG. 5 is then carried out iteratively for all the points in the sequence of points 60. FIGS. 6d and 6e illustrate how the polynomial G, the predicted point p_{pred}, the coordinate system C and the deviation D are produced for the points p(n+1) and p(n+2), respectively.

Due to the fact that the coordinate system C(n) follows the writing curve movement and is rotated dependent upon the preceding points along the writing curve, the coding is independent of the direction of movement of the writing curve. This provides a denser symbol distribution for the deviation coordinates Dₓ(n) and D_{y}(n), in comparison with if a fixed coordinate system with unchanging orientation had been used. Denser symbol distribution—or expressed in other words, lower entropy—means in turn better/higher data compression.

The method according to the invention, in addition, makes beneficial use of the characteristics of inter alia Western handwriting and the pattern of movement of a human hand, for example the fact that the handwriting movements usually swing slightly more to the left than to the right. An even denser symbol distribution is hereby achieved.

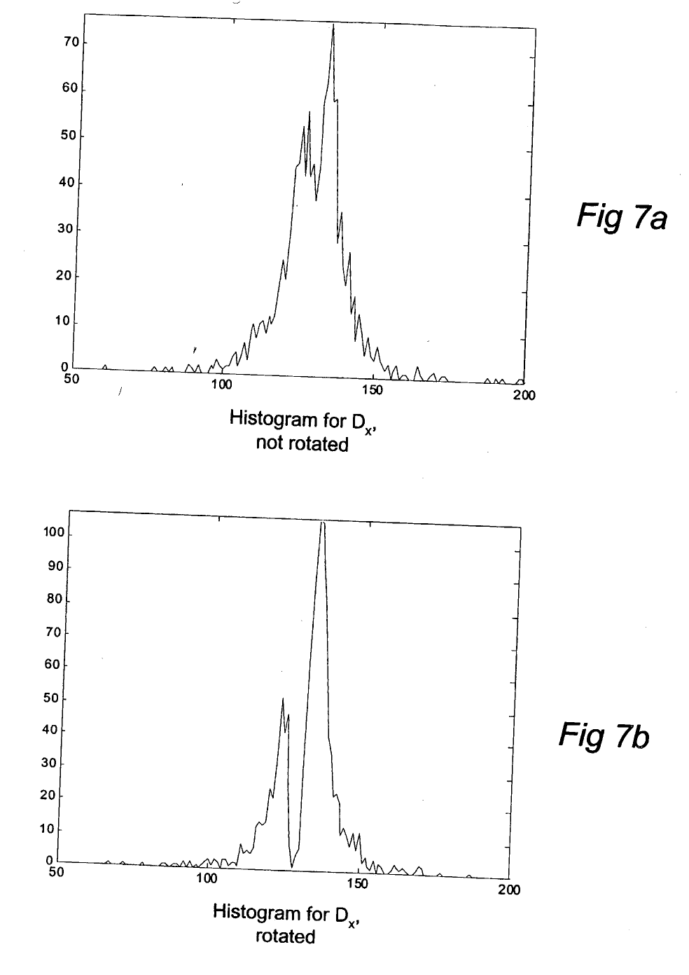

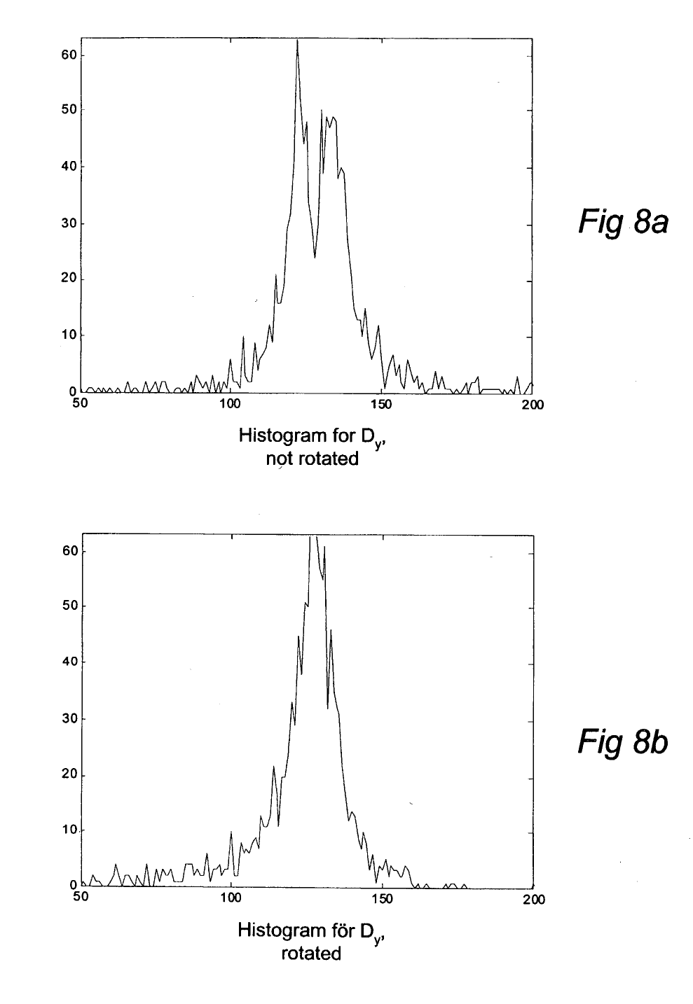

The improvement in the degree of compression that is achieved by means of the invention is illustrated by FIGS. 7a-7b and 8a-8b. For the purposes of comparison, FIG. 7a shows a histogram of the distribution of relative-coded x-coordinates Dₓ(n) for the deviations D(n) in the x-direction for the text in FIG. 1a, in the case where all these deviation coordinates are specified in one and the same coordinate system with a fixed orientation. FIG. 8a shows, in a corresponding way, a histogram of the distribution of relative-coded y-coordinates D_{y}(n), also here expressed in a static coordinate system with fixed orientation.

FIGS. 7b and 8b show, on the other hand, corresponding distributions when the coordinate system is given varying orientation for the respective points according to the inventive way of working described above. The viewer should be able to see with the naked eye that the distributions are denser in FIGS. 7b and 8b than in FIGS. 7a and 8a respectively.

The positive effect of a rotated coordinate system is also apparent from the table below. The first two columns in the table show the theoretical average bit lengths that are required in order to code the deviation coordinates Dₓ(n) and D_{y}(n), respectively, for the distributions according to FIGS. 7a/8a (row 1) and FIGS. 7b/8b (row 2) with the maximal compression. The third and fourth columns show, in a corresponding way, the average bit lengths that are required in order to code the deviation coordinates using Huffman coding according to the preferred embodiment.

| | Dₓ theoretical | D_{y} theoretical | Dₓ Huffman | D_{y} Huffman |
|---|---|---|---|---|
| Not | 5.4159 | 5.8587 | 5.4508 | 5.8872 |
| rotated | | | | |
| Rotated | 4.5282 | 5.7787 | 5.1193 | 5.8171 |

The table above shows that by representing the text in FIG. 1a in a rotated coordinate system according to the invention, 8.6% of storage space is saved compared to that required if a fixed coordinate system had been used.

As an alternative to what was described above, it is possible to define each point directly relative to the position of the immediately preceding point in the sequence. This is equivalent to a polynomial prediction of order 0.

Within the scope of the invention, it is possible to omit the resampling step completely and thus let all the recorded points undergo relative coding and compression.

In step 54, the coordinate system C(n) can alternatively be oriented in such a way that its axes are given a predetermined angle to the tangent T(n). In addition, the origin of the coordinate system C(n) can alternatively be placed with a particular predetermined offset from the predicted point p_{pred}(n).

Instead of using conversion to integer numbers according to a predetermined conversion rule during the calculations of the deviation D(n) for each point p(n), and consistently using the same conversion rule for corresponding calculations during the decoding/reproduction, it is possible alternatively to carry out periodic correction for accumulated errors that have arisen during the decoding. Such periodic correction can, for example, be achieved by each m^{th} point (for example m=16) not being stored in a coordinate system that is rotated in comparison with the immediately preceding point, but instead in a coordinate system with a predetermined orientation—a “zero rotation”. As a result, the accumulated errors will be reset after m points.

The introductory points p(0) and p(1) in a sequence of points 60 must be processed specially, as there are no earlier points on which the polynomial approximation can be based. Instead, the points p(0) and p(1) are suitably stored as absolute coordinates. Alternatively, the point p(1) can be predicted using polynomial prediction of order 0, that is 1 order lower than the rest of the points p(2), p(3), etc.

An alternative embodiment is based on a spline curve, preferably a cubic Bézier curve, fitted to the sequence of points 60. Such a Bézier curve is defined in a way well-known per se by four control points: a start point, an end point and two intermediate points. The start point and the end point lie on the Bézier curve, while the two intermediate control points often lie outside. The four control points replace the whole sequence of points 60, and it is these four control points that are stored in the storage means 16b. There is thus no need for resampling. However, polynomial prediction based on the last two control points (the second of the intermediate points and the end point) of a particular Bézier segment is used in order to predict the position of the second control point (that is the first of the intermediate points) of an immediately following Bézier segment. The first control point (the start point) of this following Bézier segment coincides with the last control point (the end point) of the preceding Bézier segment and can thus not be used for the prediction.

The deviation between the actual position and the position of the control points of a plurality of coherent Bézier segments predicted in the above way is then expressed in a rotated coordinate system, after which statistical source coding follows by analogy with what was stated above for the preferred embodiment.

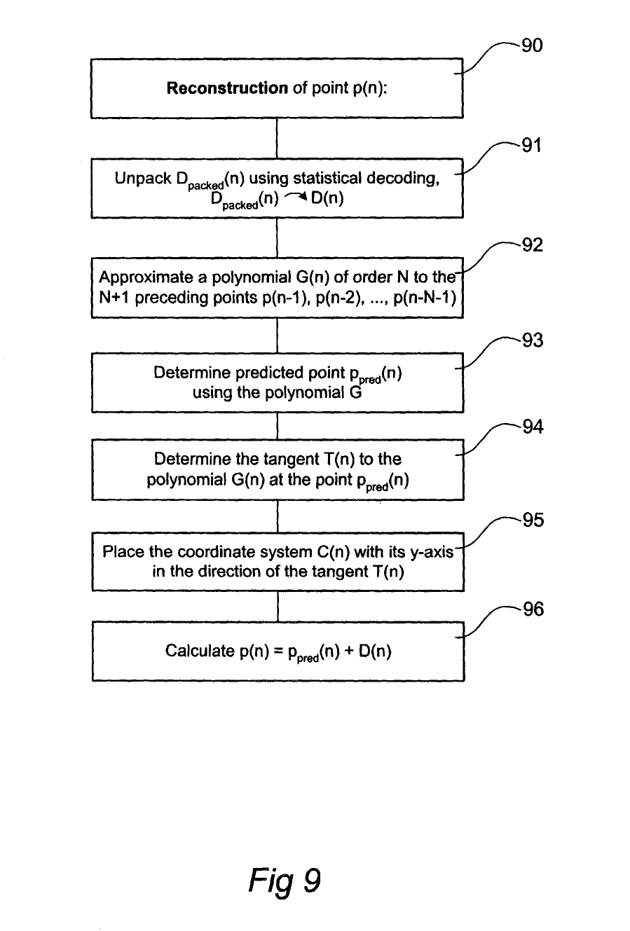

Decoding of the data, that was stored in the secondary memory 45 of the server 3 according to the preferred embodiment, is carried out according to a reconstruction method 90, which is shown in FIG. 9 for a given point p(n). After reading in the stored data (cf. step 46 in FIG. 4), unpacking of the stored compressed deviation D_{packed}(n) is carried out in step 91 to give an uncompressed deviation D(n)—or more specifically its deviation coordinates Dₓ(n) and D_{y}(n) . For this the server uses a so-called Huffman-tree, which contains a tree-like data structure where the different possible symbol values (that is possible values of the deviation coordinates Dₓ(n) and D_{y}(n)) are to be found as the leaves of the tree. Data is read bit by bit, with the tree's hierarchy being traversed level by level starting at the root of the tree. When a leaf is reached, the relevant symbol (deviation coordinate) has been decoded, and its binary value is given by the bit values along the path from the root to the leaf concerned. Decoding of the next symbol then restarts at the root. What is described in this paragraph is only a summary of the basic principle of Huffman decoding. In practice, more advanced and efficient implementations are used.

In step 92, in analogy with step 51 in FIG. 5, a polynomial G(n) of order N is approximated to the N+1 preceding points p(n−1), p(n−2), . . . , p(n−N−1). Corresponding to step 52 in FIG. 5, in step 93 a predicted point p_{pred}(n) is determined by extrapolating the graph for the polynomial G(n). In addition, in a step 94 (cf. step 53 in FIG. 5) the tangent T(n) to the polynomial G(n) is determined taken at the predicted point p_{pred}(n)

A coordinate system C(n) is then arranged in a step 95, corresponding to step 54 in FIG. 5, so that its y-axis coincides with the tangent T(n). In a step 96, the point p(n) is calculated using the predicted point p_{pred}(n) and the deviation D(n) obtained in step 91. As mentioned above, during the calculations of the point p(n) according to FIG. 9, the same predetermined conversion rule for integer number conversion is used as was previously used for the calculations of the deviation D(n) according to FIG. 5.

The invention has been described above in the form of a few exemplifying embodiments. However, the invention is in no way limited to these, but covers many other variants, according to what is defined by the scope of protection of the appended claims and, in addition, can easily be recognized by a person skilled in the art. For instance, the invention may use the prediction taught by U.S. Pat. No. 6,295,378.

What I claim and desire to secure by Letters Patent is:

1. A method for compressing electronic handwriting, the handwriting being converted into digital data representing a sequence of points along a writing movement carried out by a writing tool and a given point being defined, for storage, relative to at least one previous point in the sequence, the method including defining
said given point in a coordinate system, the orientation of which is dependent upon at least one previous point in the sequence.

2. The method as claimed in claim 1, in which the orientation of the coordinate system is dependent upon the two immediately preceding points in the sequence.

3. The method as claimed in claim 1, in which the coordinate system is dynamic such that the orientation of its coordinate axes is different for a first given point than for a second given point and depends on point(s) that precede(s) said first given point and second given point, respectively, in the sequence.

4. The method as claimed in claim 1, further comprising the steps of
determining a prediction of the position of said given point based on N+1 preceding points in the sequence;
conceptually placing the coordinate system with its origin positioned relative to said prediction in a predetermined manner and with an orientation that is dependent upon the N+1 preceding points; and
determining a deviation between said given point and the prediction, expressed in said coordinate system.

5. The method as claimed in claim 4, in which said prediction is determined by approximating a polynomial of order N to the N+1 preceding points in the sequence.

6. The method as claimed in claim 4, in which one of the axes of the coordinate system is oriented at a predetermined angle to the tangent to said polynomial taken at a position relative to said prediction.

7. The method as claimed in claim 6, in which one of the axes of the coordinate system coincides with the tangent to said polynomial taken at a position relative to said prediction.

8. The method as claimed in claim 4, comprising the further steps of
compressing said deviation; and
storing the compressed deviation.

9. The method as claimed in claim 8, in which said deviation is converted to integer according to a predetermined conversion rule prior to compression.

10. The method as claimed in claim 8, in which the compression of said deviation is carried out according to a predetermined coding algorithm for statistical coding.

11. The method as claimed in claim 10, in which said predetermined coding algorithm is Huffman coding.

12. The method as claimed in claim 4, in which N=1 or N=2.

13. The method as claimed in claim 4-12, in which the N+1 preceding points immediately precede the given point in the sequence.

14. An apparatus for recording of electronic handwriting, comprising a control unit and a storage means, the control unit being arranged to record a writing movement across a base, to determine a sequence of points along the writing movement and to store a digital representation of the points in said storage means, the control unit furthermore being arranged to determine a coordinate system for the digital representation of a given point in said sequence of points, the orientation of the coordinate system being dependent upon at least one previous point in the sequence.

15. The apparatus as claimed in claim 14, in which the control unit is arranged to carry out the method as claimed in claim 1.

16. The apparatus as claimed in claim 14, in the form of an electronic pen.

17. A computer program product that can be directly read into a memory associated with a processor, comprising program code for carrying out the steps as claimed in claim 1.

18. A method for reconstruction of electronic handwriting, represented by digital data that defines a sequence of points along a writing movement carried out by a writing tool, the method comprising the steps of
deriving from said digital data a measure of a deviation for a given point relative to a prediction of the position of the same;
determining said prediction of the position of said given point based on N+1 preceding and already reconstructed points in the sequence;
conceptually placing a coordinate system with its origin positioned relative to said prediction in a predetermined manner and with an orientation that is dependent upon the N+1 preceding points; and
calculating said given point using said prediction and said deviation, expressed in said coordinate system.

19. The method as claimed in claim 18, in which said prediction is determined by approximating a polynomial of order N to the N+1 preceding points in the sequence.

20. The method as claimed in claim 19, in which one of the axes of the coordinate system is oriented at a predetermined angle to the tangent to said polynomial taken at a position relative to said prediction.

21. The method as claimed in claim 20, in which one of the axes of the coordinate system coincides with the tangent to said polynomial taken at a position relative to said prediction.

22. The method as claimed in claim 18, in which the measure of said deviation is derived from said digital data by decompression according to a predetermined algorithm for statistical decoding.

23. The method as claimed in claim 22, in which said predetermined algorithm is Huffman decoding.

24. The method as claimed in claim 19, further adapted to reconstruct digital data that was compressed by the method as claimed in claim 1.
